(19) United States
(12) Patent Application Publication
(10) Pub. No.: US 2025/0007421 A1
(43) Pub. Date: Jan. 2, 2025

(54) SINUSOIDAL SINGLE-PHASE FREQUENCY INVERTER

(71) Applicant: Petróleo Brasileiro S.A. – Petrobras, Rio de Janeiro (BR)

(72) Inventor: Emmanuel Cordeiro DIAS, Macaé (BR)

(21) Appl. No.: 18/640,673

(22) Filed: Apr. 19, 2024

(30) Foreign Application Priority Data
Jun. 28, 2023 (BR) 1020230130054

(51) Int. Cl. H02M 7/487; H02M 1/32

(52) U.S. Cl. CPC H02M 7/487; H02M 1/32

(57) ABSTRACT

The present invention proposes a frequency inverter that provides sinusoidal output voltage without the need to use passive filters. The innovation consists of the use of strategically positioned diodes, inductors, capacitors and semiconductor switches. One of the diodes works to discharge both inductors. This innovation results in a reduction in the discharge current peaks of each inductor, which encounter two sources in series when they are in the discharge process, reduces a semiconductor element in the structure, and conditions the semiconductor switches to operate in non-dissipative switching ZVS (Zero Voltage Switching) and ZCS (Zero Current Switching) in most of the switching periods, which means that the frequency inverter being proposed has a much higher electrical performance and is compatible with commercial use. THD is also improved. The new topology being proposed makes it unnecessary to use filters at the inverter output and mitigates or eliminates problems such as motor burnout, acoustic noise, among others.

### FIELD OF THE INVENTION

The present invention falls within the field of electrical and electronic engineering. More specifically, the present invention relates to single-phase frequency inverters of innovative configuration.

### BACKGROUND OF THE INVENTION

To promote the advancement of new technological frontiers and the needs of today's society, the use of frequency inverters is mandatory and essential, especially in the current paradigm shift, with this equipment being vital and indispensable in controlling electric cars, driving motors in industrial plants, in subsea technologies such as HISEP® and in modern All Electric Oil Platforms. This equipment is also fundamental in the control and conversion of energy generated in solar, wind, hydrogen plants, etc. Therefore, it is of capital importance in the historical context of social development.

In a simplified way, the main objective of a frequency inverter is to transform direct voltage into alternating voltage. Therefore, the use of the inverter is necessary for applications in which it is essential to supply an alternating current load from a battery bank or other direct voltage sources, where what is sought is operational continuity and uninterrupted power supply. Among the several functions of an inverter, we can also mention one of its main ones: the supply and control of asynchronous electric motors, allowing the user to change its speed and power, adjusting the voltage and frequency module that feeds the motor. In this way, several research in the field of power electronics have been bringing new electronic arrangements and solving critical problems, creating conditions and paving the way for great technological advances.

Frequency inverters have several applications, among which we can highlight: driving single, two-phase and three-phase motors; Nobreaks and UPS for uninterrupted load supply; Process control; and Emergency lighting, air conditioning, etc.

Common problems with conventional frequency inverters with non-sinusoidal output are known, and can be mentioned: burning of motors due to overvoltages due to the use of inverters with non-sinusoidal voltage output PWM (Pulse Width Modulation); burning of inverters placed in parallel (example: HISEP®) to supply high power motors; harmonic distortions that can cause stress in the cable insulation system and eddy currents through the motor bearings, when using inverters with non-sinusoidal voltage output; torques that act in the opposite direction to the fundamental frequency, increase in temperature, audible noise and reduction in the useful life of the motors due to non-sinusoidal power supply; high electromagnetic interference due to the dv/dt of the non-sinusoidal PWM output voltage of the inverter.

FIG. 1 illustrates an EIE (Voltage-Current-Voltage) frequency inverter typical of the state of the art with sinusoidal output, but which does not present satisfactory electrical performance.

### STATE OF THE ART

The patent U.S. Pat. No. 11,342,850 B2, entitled “Forward converter with secondary LCD connected in parallel to perform forward and backward energy transmission”, discloses a direct converter with secondary LCD connected in parallel to perform direct and backward energy transmission, comprising a main circuit of the direct converter and an energy transfer and transmission circuit. The main circuit of the direct converter includes a high-frequency transformer T, a switching tube S, a diode D1, a diode D2, an inductance L1 and a capacitor C1. The energy transfer and transmission circuit includes a diode D3, a capacitor C2 and an inductance L2. According to the direct converter of this reference, the problems of existing magnetic reset circuit can be solved, such as low excitation power utilization rate, complex circuit composition, large loss, and low efficiency. In use with a switching power supply, the working safety and reliability of the switching power supply are improved, the power transfer and transmission circuit improves the power utilization rate, which can be widely used in the fields of computers, medical communications, industrial control, aerospace equipment, etc.

### SUMMARY OF THE INVENTION

The present invention proposes a frequency inverter that uses only one discharge diode for both inductors. This innovation results in a reduction in the discharge current peaks of each inductor, which encounter two sources in series when they are in the discharge process, reduces a semiconductor element in the structure, and conditions the semiconductor switches to operate in ZVS (Zero Voltage) and ZCS (Zero Current Switching) non-dissipative switching in most of the switching periods, which means that the frequency inverter being proposed has a much higher electrical performance and is compatible with commercial use.

### BRIEF DESCRIPTION OF THE DRAWINGS

The present invention will be described below with reference to typical embodiments thereof and also with reference to the attached drawings.

FIG. 1 is a representation of an EIE frequency inverter according to the state of the art.

FIG. 2 is a sketch of the changes made to the inverter of FIG. 1 to achieve the inverter according to the present invention.

FIG. 3 is a representation of the power part of the inverter according to the present invention.

FIG. 4 is a complete preferred representation of the inverter according to the present invention.

FIG. 5 is a representation of the equivalent circuit of the inverter according to the present invention in its first stage of operation.

FIG. 6 is a representation of the output voltage and current of a conventional inverter with non-sinusoidal output feeding a motor.

FIG. 7 is a representation of the voltage at the output terminals of a conventional inverter for several cable lengths.

FIG. 8 is a representation of the equivalent circuit of the inverter according to the present invention in its second stage of operation.

FIG. 9 is a representation of the inverter control circuit according to the present invention.

FIG. 10 is a representation of the PWM pulse generated according to the present invention.

FIG. 11 is a representation of the inverter according to the present invention in a simulation environment.

FIG. 12 is a representation of the PWM generated according to the present invention.

FIG. 13 is a magnification of the graph in FIG. 11.

FIG. 14 is a representation of the voltage and current at the output of the inverter according to the present invention at 100 Hz.

FIG. 15 is a representation of a control circuit with multiple timed switches and

frequencies, according to the present invention.

FIG. 16 is a representation of the output voltages of the inverter according to the present invention at different frequencies.

FIG. 17 is a representation of the output voltages of the single-phase EIE inverter at different frequencies.

FIG. 18 is a representation of the voltage and current in Z7 switch according to the present invention.

FIG. 19 is a representation of the voltage and current in the Z5 and Z7 switch indicating non-dissipative switching according to the present invention.

FIG. 20 is a magnification of the voltage and current in Z7 switch indicating non-dissipative commutations.

FIG. 21 is a representation of the voltage and current in Z8 switch according to the present invention.

FIG. 22 is a representation of the voltage and current in the Z6 and Z8 switch indicating the non-dissipative switching according to the present invention.

FIG. 23 is a magnification of the voltage and current in Z6 switch indicating non-dissipative commutations.

FIG. 24 is a representation of the voltage and current in Z6 switch and the output voltage of the inverter according to the present invention.

FIG. 25 is a representation of the voltage and current in D73 diode according to the present invention.

FIG. 26 is a magnification of the graph in FIG. 25.

FIG. 27 is a representation of the voltage and current in D72 diode according to the present invention.

FIG. 28 is a representation of the voltage and current in D75 diode according to the present invention.

FIG. 29 is a representation of the currents in L10 and L14 inductors according to the present invention.

FIG. 30 is a representation of the performance of the EIE inverter from the state of the art.

FIG. 31 is a representation of the inverter performance according to the present invention at different frequencies.

FIG. 32 is a representation of a simulation of the inverter according to the present invention.

FIG. 33 is a representation of the output voltage with current in R3, in R4 and total current according to the present invention.

FIG. 34 is a representation of the dynamic regulation of the inverter according to the present invention.

FIG. 35 is a representation of the response without overshoot for total load removal in the inverter according to the present invention.

FIG. 36 is a representation of the response to insertion of inductive loads of the inverter according to the present invention at 100 Hz.

FIG. 37 is a representation of the inverter with half-wave rectifier as load according to the present invention.

FIG. 38 is a representation of the output voltage and current in the load of FIG. 37.

FIG. 39 is a representation of the inverter with thyristors and load RL at the output according to the present invention.

FIG. 40 is a representation of the firing of thyristors in antiparallel and RL load according to the present invention.

### DETAILED DESCRIPTION OF THE INVENTION

Specific embodiments of the present disclosure are described below. In an effort to provide a concise description of these embodiments, all features of an actual implementation may not be described in the specification. It should be appreciated that in the development of any actual implementation, as in any engineering or design project, numerous implementation specific decisions must be made to achieve the specific objectives of the developers, such as compliance with system- and business-related constraints, which may vary from one implementation to another. Furthermore, it should be appreciated that such a development effort may be complex and time-consuming, but would nevertheless be a routine design and manufacturing undertaking for those of ordinary skill having the benefit of this disclosure.

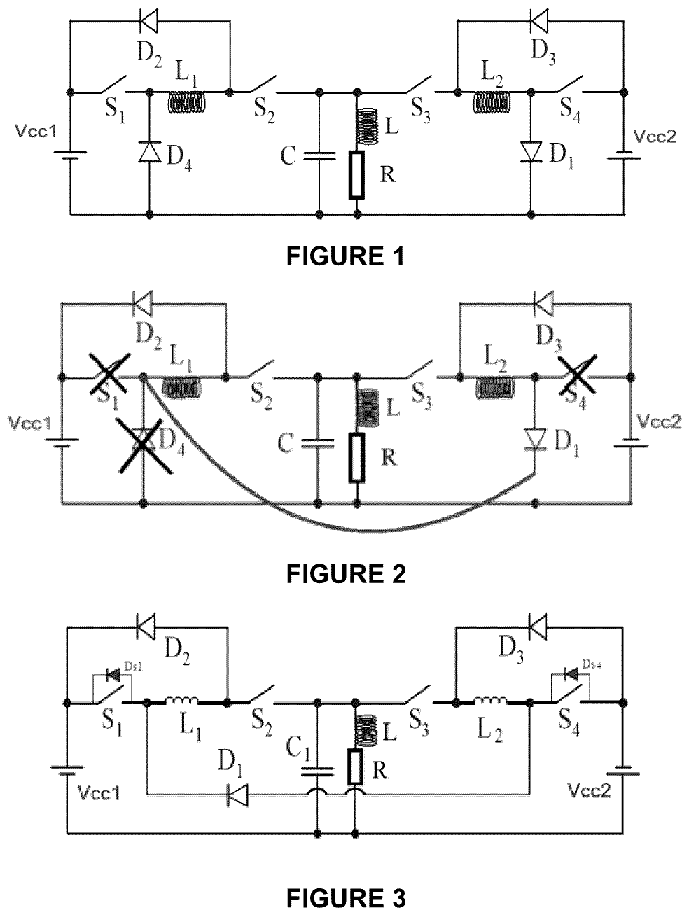

FIG. 1 illustrates a basic scheme of a Single-Phase EIE Inverter with RL load. Note the presence of four diodes, D1, D2, D3 and D4, in which D2 and D4 carry out the discharge (Freewheeling) of inductor L1 and diodes D1 and D3 carry out the discharge of inductor L2. Switches S1, S2, S3 and S4 are controlled to change the direction of current reaching the load.

Since the operation of the EIE Single-Phase Inverter is well known, details about this will not be given.

FIG. 2 illustrates an outline of the changes proposed by the present invention, called Single-Phase ECD Inverter (Energy-Capacitor-Dual). Diode D4 is eliminated and switching keys (switches) S1 and S4 are replaced by bidirectional current switches, so that the discharge of both inductors L1 and L2 is done by the same diode D1. The resulting circuit is visualized in FIG. 3.

Preferably, the voltage sources Vcc1 and Vcc2 are Symmetrical DC sources, and batteries, solar panels, hydrogen cells, etc. can also be used. Switches S2 and S3 are simple unidirectional semiconductor switches like transistors, thyristors, etc. Bidirectional current switches, such as Mosfets, IGBTs, or IGCTs, can be used without compromising the operation of the inverter. Capacitor C1 is a depolarized capacitor; diodes D1, D2 and D3 are fast recovery diodes or Schottky diodes (when applied at low voltages); and inductors L1 and L2 are ferrite core inductors.

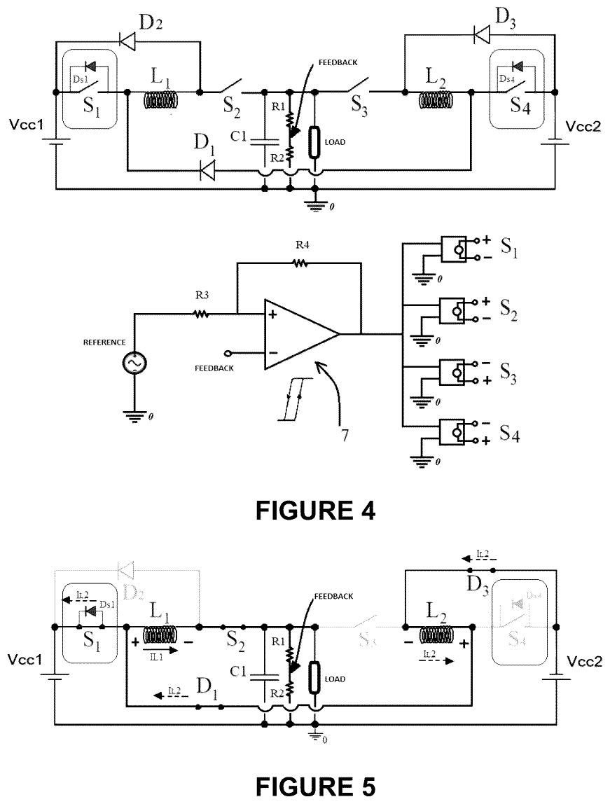

FIG. 4 is a preferred representation of the complete topology of the ECD inverter, including the control circuit for switches S1, S2, S3 and S4, according to the present invention. It is necessary and essential to use bidirectional semiconductor switches with current in S1 and S4. Therefore, switches must be used that have body diodes, which provide the characteristic of bidirectional current conduction to these switches, named in FIG. 4 as Ds1 and Ds4 (also called antiparallel diodes), which are inherent or intrinsic to these types of switches. In order the discharge of inductors L1 and L2 to be possible, these diodes are essential, as they make the path for the discharge current of the inductors possible.

Diode D4 was removed from the single-phase EIE structure, enabling the creation of the Single-Phase Inverter ECD and enabling its operation, together with the exchange of simple semiconductor switches S1 and S4 for bidirectional current switches that can allow the closure of the discharge circuit loop of the inductors.

Switches S2 and S3 do not need to be bidirectional in current, as the discharge current from the inductors does not flow through them, as occurs in switches S1 and S4. However, optionally the use of all bidirectional semiconductor switches can be made, which is advantageous both in simulation and in practice. This is because it avoids or reduces possible electrical differences between the characteristics of the switches that could impair the proper switching of the arms and allows current flow in cases where three-phase motors return energy, such as in the event of a short-circuit or in situations where power regeneration occurs.

In this preferred configuration, the ECD inverter of the invention is assembled as follows:
the positive terminal of the Vcc1 source connects to the cathode of diode D2 and to the drain or collector (depending on the switch used, Mosfet, IGBT, Transistor, etc.) of the bidirectional current switch S1;
the source/emitter terminal of switch S1 connects to the cathode of diode D1 and to a terminal of inductor L1;
the other terminal of inductor L1 connects to the anode of diode D2 and to the drain/collector of switch S2;
the source/emitter terminal of switch S2 connects to one of the terminals of capacitor C1, to one of the terminals of the load to be supplied and to the drain/collector of switching switch S3;
the source/emitter terminal of switch S3 is connected to the cathode of diode D3 and to one of the terminals of inductor L2;
the other terminal of inductor L2 is connected to the anode of diode D1 and to the drain/collector of the bidirectional current switch S4;
the source/emitter terminal of the current bidirectional switch S4 is connected to the anode of diode D3 and to the negative terminal of the source Vcc2;
the negative terminal of the source Vcc1 is connected to the other terminal of the capacitor C7, to the other load terminal and to the positive terminal of the source Vcc2;
in parallel to the capacitor C1 and the load, two resistors R1 and R2 are connected in series, a voltage sample being taken in the middle of this resistive divider and sent directly to the inverting input of a hysteresis comparator.

A resistor R3 receives the signal that is intended to be obtained at the inverter output, in this case a low voltage sinusoidal signal is placed, which is called a reference. The other end of resistor R3 is connected to the non-inverting input of the hysteresis comparator and another resistor R4. The other end of resistor R4 is connected to the hysteresis comparator output connector, closing the PWM signal generating loop. The PWM signal generated is sent to 2 voltage isolation drivers (optical or galvanic) that activate switches S1 and S2. This same PWM signal is sent to 2 other isolation drivers that must invert it (change its polarity) and activate switches S3 and S4.

To generate the sinusoid at the output of the ECD inverter according to the present invention, it is necessary to use a reference sine wave with low amplitude that is compared to a feedback signal sampled from the inverter output terminals themselves, generating a PWM signal that activates the semiconductors and allows the creation of a sine wave at its output, with the module varying according to the change in the amplitude of this feedback signal or the change in the amplitude of the reference sine signal. Both variations act to change the amplitude of the sinusoidal signal at the inverter output terminals.

It can be seen that it is also possible to generate other types of voltage at the inverter output, since it works as a voltage follower. This way, if a triangular wave, square wave, audio signal or any other wave is applied, for example, in the comparator circuit, the inverter will be able to reproduce these waveforms at its output, however, responding with a higher harmonic distortion in the signal, for the higher frequency spectrum of that reference signal. Regarding the number of elements, in the Single-Phase Inverter of the present invention, for example, there are as main elements, four semiconductor switches, two of which are necessarily bidirectional in current, two inductors, three diodes and a capacitor in its main structure. Two symmetrical DC voltage sources are required for power supply and control must be done using a voltage comparator.

### Technical Problem Solved by the Invention

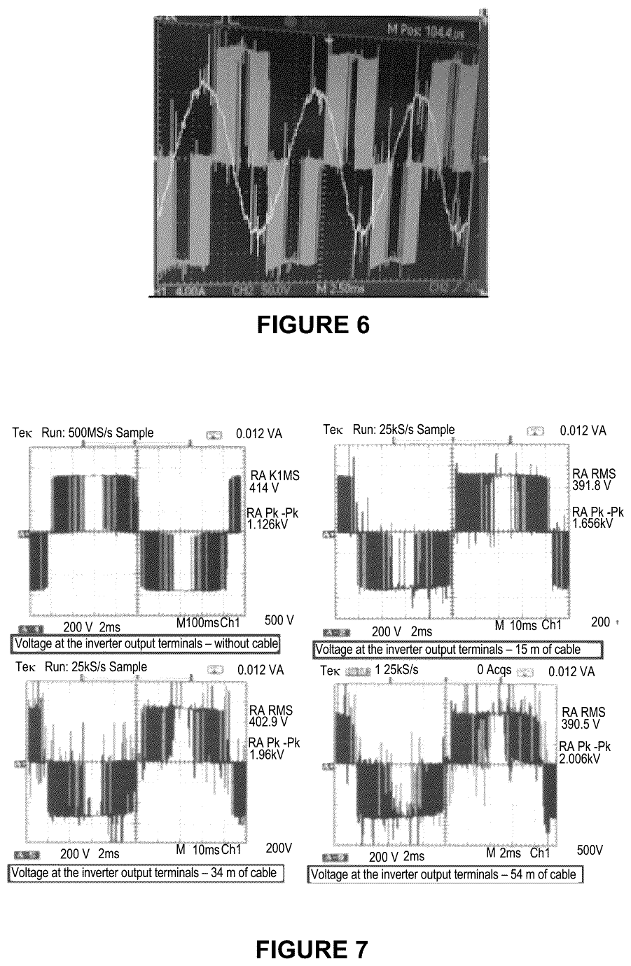

Burning out motors due to voltage wave reflection in inverters with non-sinusoidal output is a subject that has been taking up space in maintenance, as these frequency inverters have semiconductor switches in their output stage with conduction start time (turn-on) very fast, which results in voltage pulses with high dv/dt in the output voltage, which, combined with high cable lengths and the switching frequency of the PWM system, can cause the phenomenon of voltage reflection. FIG. 6 shows a typical PWM switch, where the pulse width varies throughout the switch. It can be seen that the time between pulses is very short, the conduction times are very fast and the voltage that reaches the motor terminals is not sinusoidal (PWM waveform).

When the inverter with a non-sinusoidal output emits a voltage pulse, the immediately preceding pulse has not yet been fully damped by the motor impedance, causing them to overlap, which may lead, in some cases, to doubling the voltage at the terminals of the motor. In this way, the voltage pulse, upon reaching the motor terminals, causes the first turn(s) of the first coil of a given phase to be subjected to a high value of voltage.

FIG. 7 exemplifies the reflection problem well. Voltage measurements were carried out at the output terminals of an inverter with different cable lengths, where the influence of transients on the power supply to the motor driven by a WEG model CFW09 frequency inverter can be verified. The longer the cable, the greater the number and level of voltage peaks that appear in the output voltage of the inverter.

Other serious problems, such as bearing failures due to capacitive discharge, high acoustic noise in the motor, increased losses and temperature, need to use power derating due to harmonics, increased vibration level, loss of performance, degradation of coil insulation, are all problems caused by the use of PWM inverters with non-sinusoidal output. There are several complications caused, and problems with radiated and conducted noise, known as electromagnetic interference-EMI, may also be mentioned.

All of this, in many cases, forces the user to resort to different solutions to mitigate these problems. Commonly used solutions are changes in the switching frequency, use of larger or special motors, use of cables with more robust insulation or even those that use output filters in the inverter, such as reactors, sinusoidal filters, dv/dt filters, RC filters, LCL filters, etc. However, resorting to the use of filters at the inverter output also brings other chronic problems, including: the inductors used, on certain occasions, are expensive, bulky and heavy, impacting the size of the cabinets; need for adjustments and tuning between resonance frequencies and switching frequencies; great difficulty or even impossibility of parallelizing two or more inverters due to electrical differences between the filter values (appearance of unwanted resonances between the inverters and impossibility of activating the motor), etc.

Advantageously, the ECD Inverter of the present invention brings to light solutions and mitigations for these many and severe problems, as it produces sinusoidal output voltage with low harmonic distortion, avoiding burning of the coils, bearing failures, without affecting the performance of the engine, reducing vibrations and noise, etc., all these benefits associated with the non-necessity of using output filters. These and other advantages will become evident from the following description.

### Operation Steps

Observing the characteristics of the single-phase ECD Inverter according to the present invention, we can describe two operation steps for it, presented below:

First Step: Δt1 [t1−t0]

Initially, the single-phase ECD Inverter according to the present invention is in a resting state as in FIG. 4. At the moment when switches S1 and S2 close at a time t0 and remain closed until a time t1, the circuit equivalent of the single-phase ECD Inverter of the present invention takes the form seen in FIG. 5. The voltage on the output capacitor C1 begins to increase linearly, due to the energy stored in the inductor L1, in association with the input voltage source Vcc1. The partially erased components in FIG. 5 do not conduct at this stage. If there is energy stored in inductor L2, this energy is discharged through power supplies Vcc1 and Vcc2, through diodes D1, D3 and Ds1 (antiparallel diode of switch S1) which are directly polarized. The path taken by the discharge current IL2 can also be seen in FIG. 5 using the indicative arrows. The switch S1 in this step conducts current IL1 and current IL2 through the antiparallel diode Ds1 at the same time.

Second Step: Δt2 [t2−t1]

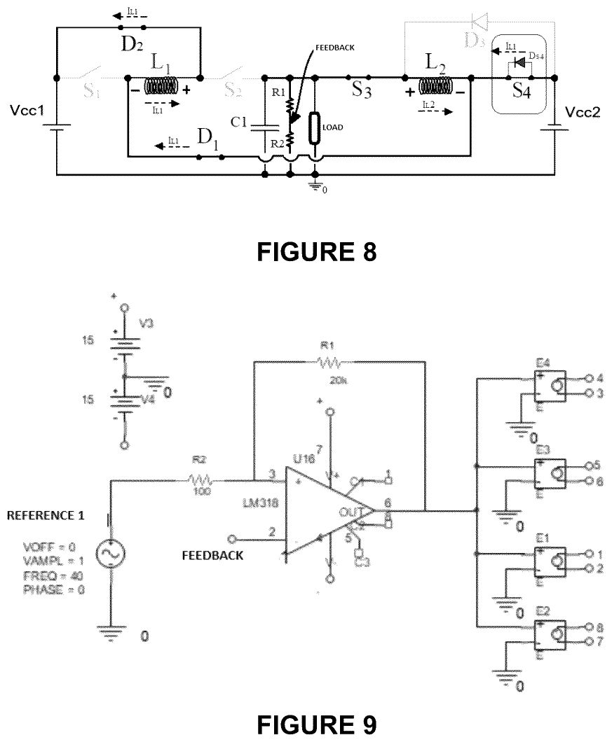

In this step, switches S1 and S2 open at time t1 and, simultaneously, switches S3 and S4 are closed and remain closed until time t2. The current source constituted by elements L2 and Vcc2 causes the voltage on the output capacitor C to decrease linearly, as can be seen in FIG. 8. Partially turned off components do not conduct at this stage. In this step, diodes D1, D2 and Ds4 conduct current from inductor L1, if it has stored energy, which is transferred to power sources Vcc1 and Vcc2. The path taken by the discharge current IL1 can be visualized in the same way in FIG. 8. The switch S4 in this stage conducts current IL2 and current IL1 through the antiparallel diode Ds4 at the same time.

Important observations must be made for the steps presented above. Taking the second stage as an example, just before switch S4 is commanded to close and start conducting the load current IL2, the demagnetization current IL1 already puts the body diode of that switch into conduction immediately, due to inductor L1 does not allow instantaneous variation of current at its terminals and continues to conduct current through diodes D1, D2 and Ds4. The same phenomenon occurs with switch S1 when it is commanded to close.

Therefore, when these switches are commanded to operate, they will close in non-dissipative switching ZVS (Zero Voltage Switching), or zero voltage switching, since the current was flowing through their body diodes before their activation, thus guaranteeing its closures at zero voltage.

The ZVS closing of switches S1 and S4 does not occur in all switch activation cycles and varies with the type of load activated.

A fact to be pointed out also refers to the ZVS switching in the negative half-cycle for key S1 and positive for key S4 of the output sinusoidal signal.

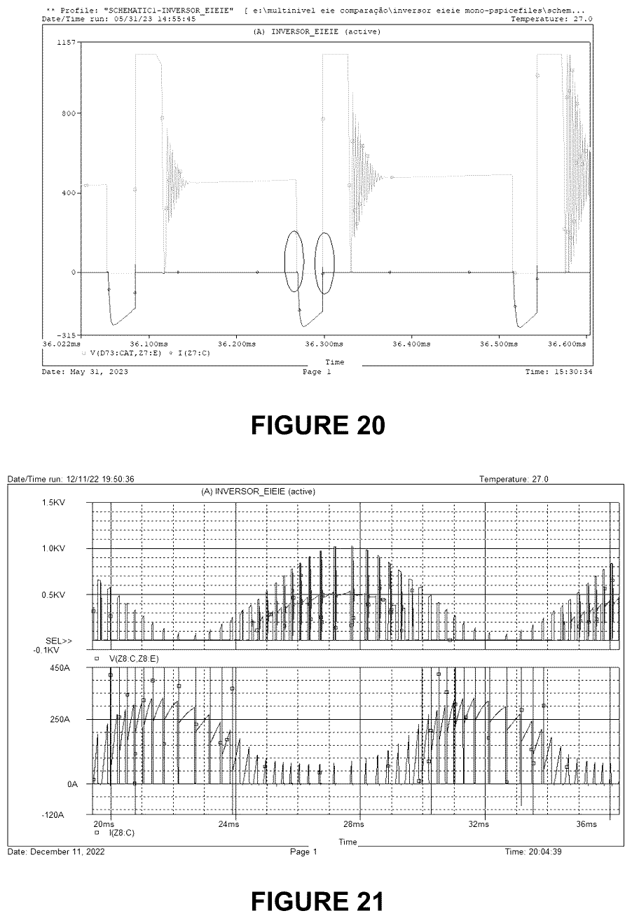

During the entire negative half-cycle period of the sinusoid, it is observed that the switch S1 operates in non-dissipative switching ZVS both at the input and at the conduction output, as can be seen in FIG. 19 of the simulation. It can be seen that the current conduction during this period is entirely carried out by the body diode of this switch, as can be seen in the magnification of FIG. 20.

The same occurs with switch S4, which operates in non-dissipative switching when opening and closing throughout the positive period of generation of the output sinusoid.

Switches S1 and S4 operate in this way, in ZVS mode both when opening and closing the switches on these occasions, since the antiparallel diodes of these switches are conducting current, without therefore presenting undesirable crossovers between voltage and current.

Non-dissipative switching is also verified in the activation of switches that are connected to the output capacitor, however presenting ZCS (Zero Current Switching) switching, or zero current switching, as a characteristic.

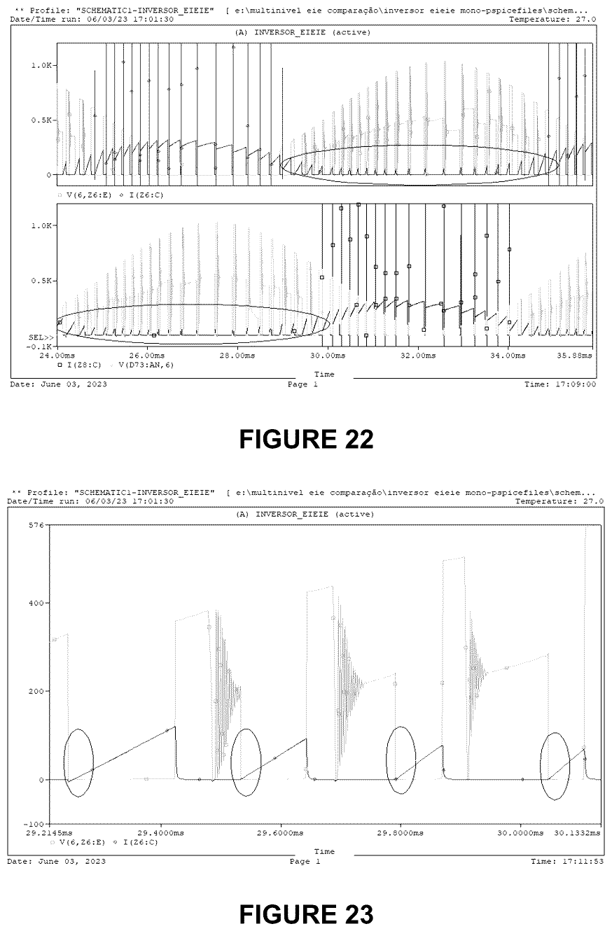

ZCS switching at the conduction input in switch S2 occurs when the voltage generated is the negative half cycle of the output sinusoid, and in switch S3, ZCS switching at the conduction input occurs when the generation of the output voltage is in the positive half cycle. Both switches feature ZCS non-dissipative switching at the conduction input, which is highlighted in the simulation stage, indicated in FIG. 22.

FIG. 23 shows a magnification at the conduction input of switch S3 (Z6), indicating the ZCS non-dissipative switching at the conduction input of that switch. This fact is explained because in the positive period of generation of the output sinusoidal voltage, when the output capacitor voltage linearly decreases, it is observed that there is a discharge of a high current from the inductor L1 (L10) occurring through the switch body diode S4 (Z5) and also a current that causes the voltage on the output capacitor to decrease linearly and that also passes through this switch S4 and through switch S3.

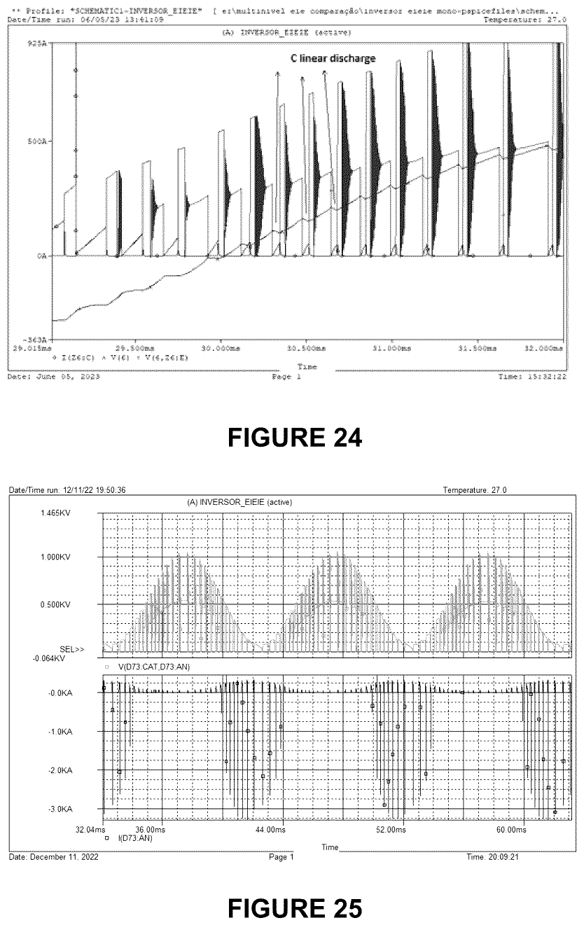

Then, there is a current source given by the inductor L1 (L10) and another current source given by the inductor L2 (L14), one discharging its energy into the higher intensity Vcc sources and the other supplying energy for the linear discharge of the voltage of the capacitor, of lower intensity. In this way, inductor L2 causes the current to rise linearly at this time in switch S3 (Z6), as shown in FIG. 22, FIG. 23 and FIG. 24.

It is interesting to verify this fact in the currents, which have very different values in switches S3 and S4 in the positive period of generation of the sinusoidal voltage, even though they are in series, because in switch S4 the current is given by the sum of the current that comes from inductor L1 (and circulates through its body diode Ds4) with the current passing through inductor L2 and switch S3.

The ZVS and ZCS characteristics act by increasing the performance of the inverter and reducing electromagnetic interference-EMI emitted and radiated, reducing the high di/dt and dv/dt, inherent to the switching of controlled semiconductor devices.

### PWM Control

The control of semiconductor switches S1, S2, S3 and S4 can be carried out by any device that is configured as a hysteresis comparator and that has high speed and high slew rate, for example, LM318, LM218, or RC4559, without being limited to these. For convenience, the control device will hereinafter be referred to simply as the hysteresis comparator.

As switches S1 and S2 always work together, and inversely to switches S3 and S4 (when one pair is activated, the other pair is necessarily open), it is possible to use the same PWM created for a pair of switches and reverse this sign for the other pair. In simulation software, for example, such as PSIM, ORCAD, PSCAD, or PROTEUS, simply change the order of the numbers of the gate-source trigger bubbles of the other pair of drivers (bubbles 4 and 3, 8 and 7), which reduces the complexity of the control structure, as can be seen in FIG. 9.

To generate the PWM, a sample proportional to the voltage on the output capacitor C1, called the Feedback 1 signal, is sent to the inverting input of the comparator. The non-inverting input receives the reference signal, here called Reference1. This reference signal is nothing more than the signal that is intended to be obtained at the inverter output. Therefore, a sinusoidal signal that allows its variation must be connected to this terminal. In practical terms, it can be created by a sinusoidal signal generator that allows changing its frequency and amplitude, for example, PSG9080 or FY8300S-20M. By changing the frequency and amplitude of this signal, it becomes possible to control the speed of a motor, for example. This reference signal, which can be a sinusoid, triangle wave, square wave, audio signal, etc., inserted into the non-inverting terminal of the hysteresis comparator is reproduced at the output of the ECD inverter. Therefore, when, for example, a low-amplitude sine wave is inserted into this terminal and its amplitude and frequency are changed, the output will be a sinusoid similar to this one, but with the capacity to drive large loads.

The hysteresis comparator, therefore, as it has infinite gain, produces discrete pulses at its output depending on the comparison between the signal level applied to the inverting port and the non-inverting port, that is, between the reference and feedback. For the Single-Phase ECD Inverter of the present invention, the use of feedback resistors in the comparator was carried out, changing the hysteresis cycle. As a result, it was possible to reduce the switching frequency of the generated PWM, reducing it to an approximate maximum value of up to 10 kHz. It should be noted that the value of the switching frequency is not fixed and may vary over the course of the applied signal. The frequency of 10 kHz is considered a typical threshold, but not limiting.

This reduction in the switching frequency being presented also contributed to increasing the electrical efficiency of the inverter.

The hysteresis comparators from the state of the art did not use resistors, which resulted in an extremely small operating hysteresis cycle, generating a PWM of the order of 100 kHz and output sine waves with THD of the order of 1%, however, with very low overall electrical efficiency.

The use of such resistors leads to greater electrical efficiency of the inverter according to the present invention, as it translates into lower switching frequencies. However, use without resistors in the comparator can be carried out, but at the expense of lower electrical efficiency of the inverter. Values of R1 between 10 and 200 ohms and of R2 between 10 k and 50 k ohms can be used, and their values can be varied in order to improve the electrical performance of the ECD inverter and the output THD.

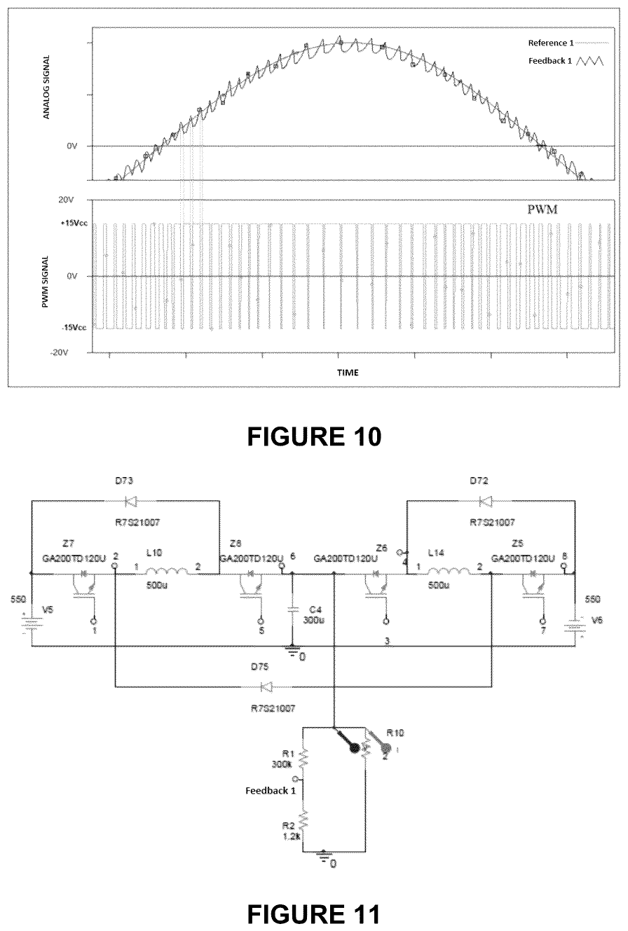

Referring to FIG. 10, in this type of hysteresis control the generated pulses control the power switches (S1 to S4) causing the inverter output voltage to present the same waveform as the reference signal, so that, under ideal conditions, the only difference would be the gain of the feedback loop. The gain of the feedback loop in this topology is changed when the relationship between resistors R1 and R2 of the resistive divider, parallel to capacitor C1, is modified. Another way to change the gain of this topology, as previously mentioned, is by modifying the modulus or signal amplitude of the Reference 1 signal.

### Simulations

The waveforms that will be described below were generated in the purchased software Orcad® 2022, however other computer programs such as any electronic circuit simulator program can be used such as: PSIM, PSCAD or PROTEUS. In the waveforms marked (A) INVERSOR_EIEIE (active) are data relating to the simulations in the Single-Phase ECD Inverter according to the present invention, and in the waveforms marked as (A) INVERSOR_EIE_MONO (active) are data relating to the EIE Single-Phase Inverter from the state of the art for comparison purposes. In the simulation of the ECD Single-Phase Inverter, the components from table A below were used, which make up the main power part, as exemplified in the simulated circuit in FIG. 11.

TABLE A
Simulation parameters

| Device | Specification | Amount |
|---|---|---|
| CC sources (V5, V6) | 550 Vcc | 2 |
| Diodes (D72, D73, D75) | R7S21007 | 3 |
| IGBTs (Z5, Z6, Z7, Z8) | GA200TD120U | 4 |
| Inductors (L10, L14) | 500 μH | 2 |
| Capacitor (C4) | 300 μF | 1 |
| Resistor (R1) | 300 kΩ | 1 |
| Resistor (R2) | 1.2 kΩ | 1 |

### Simulation of Control and Output Voltages

To feedback the output signal, a 300 KΩ resistor was used in series with a 1.2 KΩ resistor, which resulted in an approximate gain of 251, given by dividing 300 added to 1.2, divided by 1.2. For control, an LM318 voltage comparator was used, responsible for generating the PWM signals. It was also necessary to use four voltage isolator drivers, responsible for isolating the PWM signal generated. As a load at the output, a 2 Ω resistor R was initially used, generating an average dissipated power of 66.8 kW calculated according to equation 1:

$$Poutput = \frac{{( \frac{Vpico}{\sqrt{2}} )}^{2}}{R} = \frac{{( \frac{517}{\sqrt{2}} )}^{2}}{2} \approx 66.8 kW \qquad ( 1 )$$

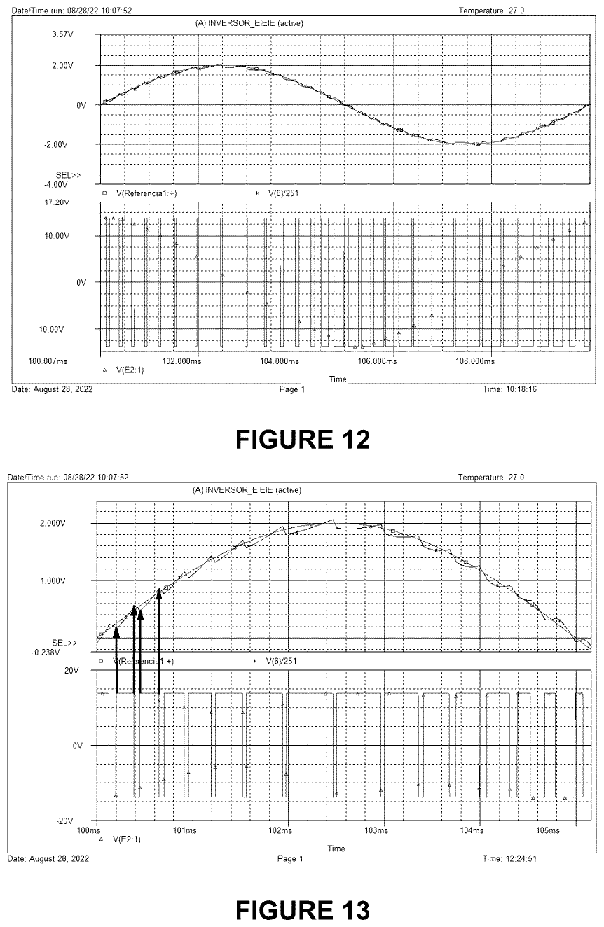

FIGS. 12 and 13 show the reference, feedback and PWM waveforms generated in simulation, where FIG. 13 is a magnification of the curve seen in FIG. 12.

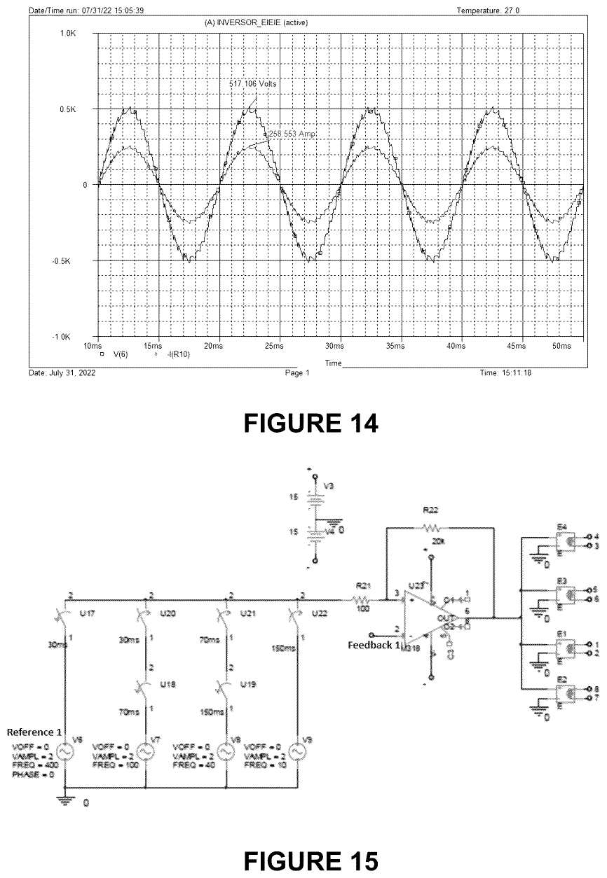

FIG. 14 shows the current and voltage waveforms simulated at the output of the ECD inverter according to the present invention with a load of 2 $2 and a frequency of 100 Hz, resulting in a peak current of 258 A and a peak voltage of 517 Vac.

In order to verify and visualize the output voltage of the new topology proposed by the present invention at different frequencies, but in the same waveform, an arrangement with timed switches U17, U18 and U20, U19 and U21, and U22 as shown in FIG. 15 was inserted into the control circuit, removing and inserting the reference voltage sources V6, V7, V8 and V9 at a certain period. The frequencies of 400 Hz, 100 Hz, 40 Hz and 10 Hz were chosen, with a VAMPL peak value of 2 Vac and a phase angle equal to zero. Specifically, the procedure performed was to start with the 400 Hz sinusoidal signal and remove it after 30 ms; insert the 100 Hz sinusoidal signal at 30 ms (simultaneously removing the previous signal) and remove it at 70 ms; insert the 40 Hz signal at 70 ms and remove it at 150 ms; and insert the 10 Hz signal at 150 ms.

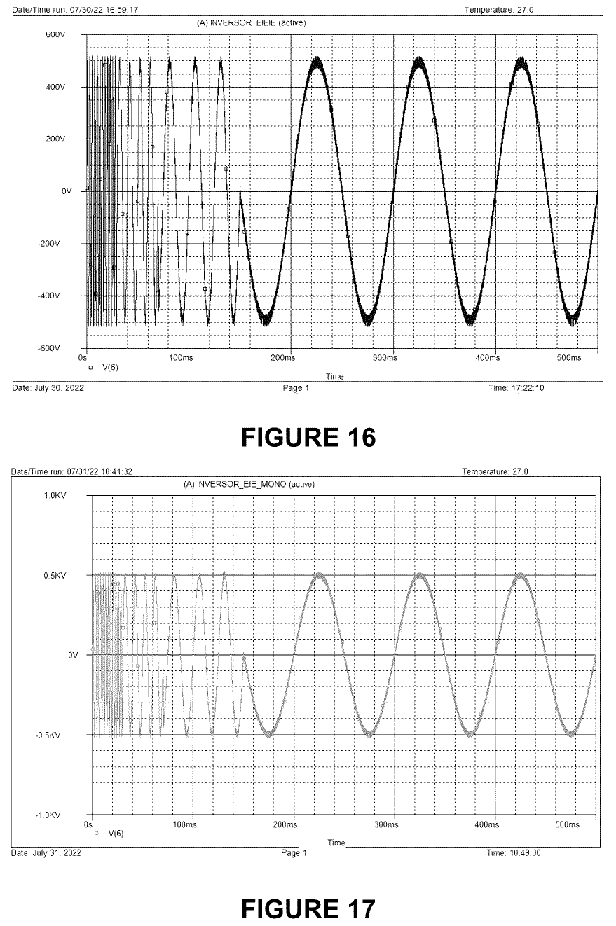

FIG. 16 shows the sinusoidal output characteristic with low harmonic distortion at all frequencies used for the 2 Ω load. Note the serrated characteristic of its composition, a typical property of a voltage follower without, however, compromising the resulting sinusoidal waveform at all four frequencies. Waveforms with lower harmonic distortions can be achieved by simply increasing the input voltage value of the reference wave. Or, further, reducing the hysteresis cycle by changing the values of resistors R21 of 100 Ω and R22 of 20 KΩ. In this simulation, these values were used, as they allowed an overall efficiency of the structure greater than 91% at 100 Hz.

Simulations on the EIE inverter from the state of the art were also carried out, for comparison purposes, using the same values of the electronic components used in the simulation of the ECD Inverter described above. In FIG. 17, the output voltage of the EIE Inverter for the four frequencies can be observed and its similarity to the output voltage of the ECD Inverter. Both present the same characteristic and response values when comparing FIGS. 16 and 17.

### Waveforms

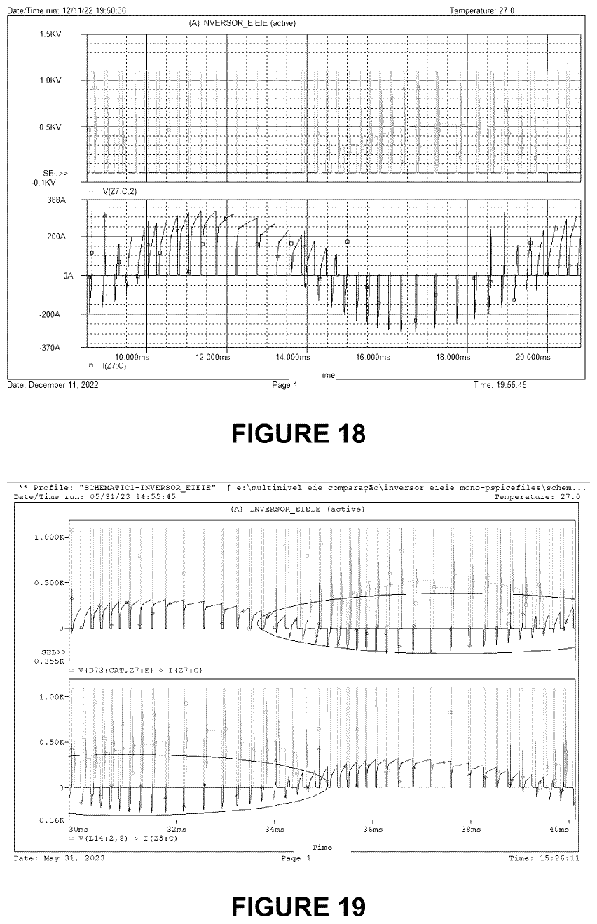

The main waveforms of the Single-Phase ECD Inverter according to the present invention will be discussed below, using a load R of 2 Ω and a frequency of 100 Hz (example in FIG. 11). FIG. 18 shows the voltage and current in the bidirectional switch Z7. As capacitor C4 sometimes receives energy from one of the symmetrical current sources Vcc1, sometimes from the other Vcc2, the waveforms in switch Z5, therefore, are similar to those in switch Z7, but phased by 180 degrees, not being necessary to outline them here. The same occurs with the other switches Z8 and Z6, with similar waveforms, but 180° out of phase. It can be seen that the voltage on switch Z7, when it opens, is equal to the sum of the voltage of the two sources, in this case, 1.1 kV, requiring attention when choosing it.

FIG. 21 shows the voltage and current on switch Z8. A voltage value close to the sum of the source voltages is also verified, making it therefore necessary to choose switches with blocking voltage levels higher than the sum of these.

Now the voltage and current waveforms in diodes D73 and D72 will be analyzed.

With reference to FIG. 25, the voltage values on diode D73 at the time of blocking are equal to the sum of the voltage of the sources, as occurs in all semiconductor switches. The current in the transition from conduction to blocking in diode D73 presented peaks with values close to 3 kA. This value must be compared to the data reported in the datasheet to verify proper operation. In this case, for the R7S21007 diode, a maximum peak or surge current in the forward direction was indicated −IFSM=Maximum (peak or surge) forward current or One-Half Cycle Surge Current of 6.5 kA. No data were found in the datasheet for the maximum direct current value (IFM), or maximum current in repetitive regime.

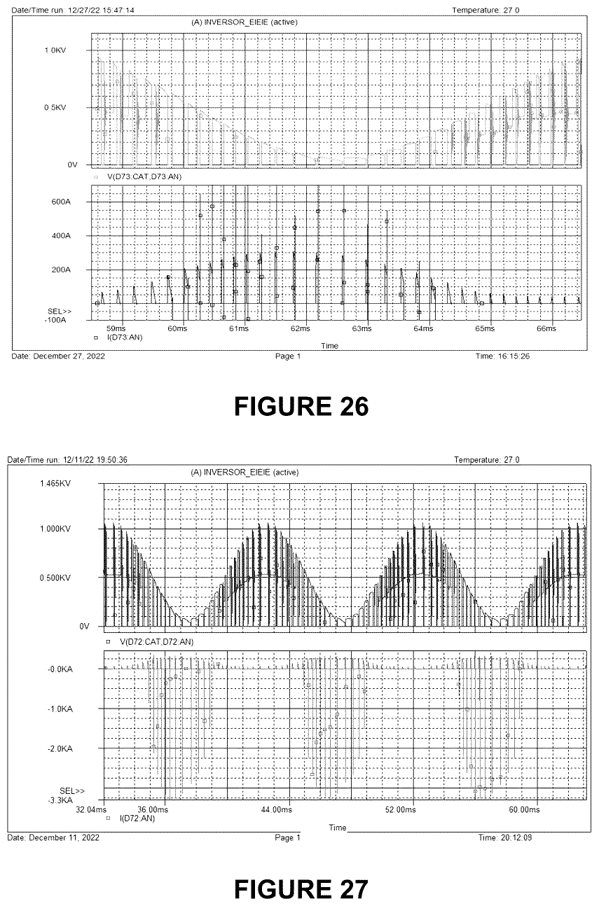

By way of comparison, in the single-phase EIE inverter from the state of the art, even higher current peaks are observed, on the order of 4 kA, therefore, the single-phase ECD inverter of the present invention responds better to switching transients for diode D73. In FIG. 26, a magnification of the voltage and current of diode D73 in FIG. 25 is shown.

Diode D72 presented a blocking voltage equal to the sum of the source voltage and the circulating current, similar to diode D73. Current peaks were also visualized in the transitions, as shown in FIG. 27.

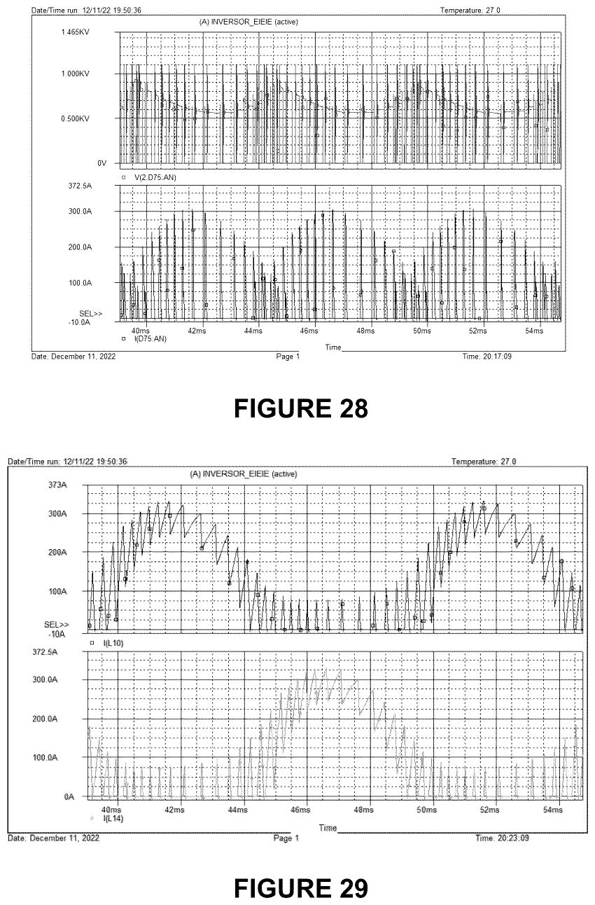

It will also be observed in FIG. 28 that the voltage value over diode D75 at the time of blocking is also equal to the sum of the source voltages, which allows to state that all semiconductors used in the ECD inverter of the present invention must have their chosen voltage values are at least equal to the sum of the Vcc voltages of the sources.

The current in diode D75 did not present current peaks in the transition from conduction to blocking, unlike diodes D73 and D72. Its conduction is verified in both inductor discharge cycles as previously indicated, confirming the functioning of the innovative topology presented here.

Finishing the main waveforms, in FIG. 29 is observed the currents in inductors L10 and L14.

### Yield Simulations

In terms of performance response, a great advance obtained with the creation of the ECD inverter being disclosed compared to the EIE Inverter from the state of the art is observed. In two different simulations carried out on the EIE Inverter, one of them using hysteresis control without feedback resistors, resulting in a very high PWM frequency (in the order of 80 to 100 kHz), and another using 100 Ω and 20 KΩ resistors in the comparator, generating PWM frequency with pulses of approximately 10 kHz maximum order, a performance much lower than that obtained using the ECD inverter of the present invention was verified.

To calculate the yields and graphic plots, equation 2 below was used, where the average output power at the load (Resistor R10) is divided by the sum of the average power that is drained from the two voltage sources (Sources V5 and V6), indicating the approximate efficiency of the inverters:

$$η = \frac{AVG ( W ( R 10 ) )}{- AVG ( W ( V 5 ) ) \text{-} AVG ( W ( V 6 ) )} * 100 \% \qquad ( 2 )$$

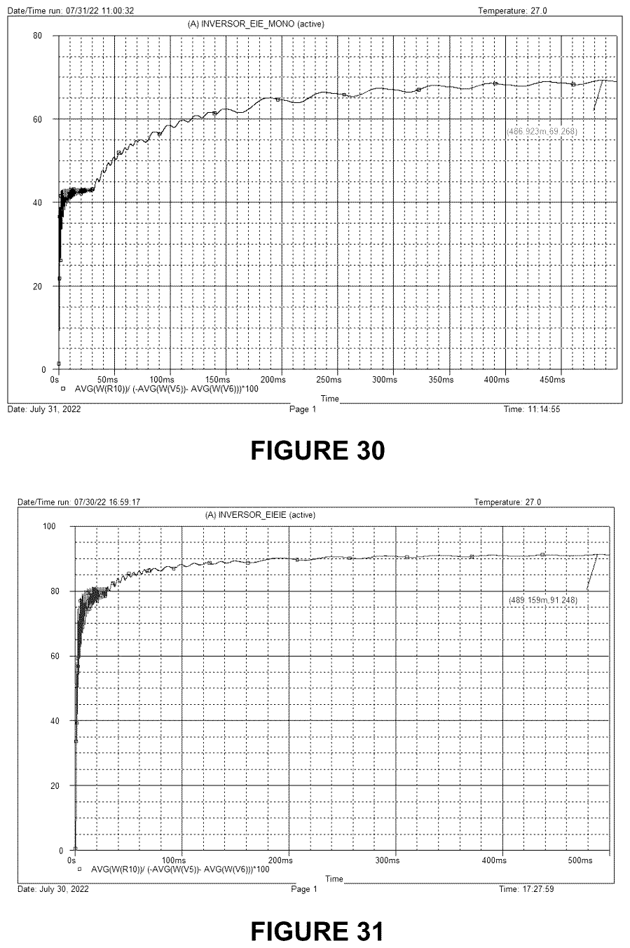

In the first simulation, using the EIE Single-Phase Inverter from the state of the art at high frequency and without resistors in the comparator, a very low THD value at the output voltage is obtained, however, the worst response in simulated efficiency is obtained. A maximum value of just 69.2% performance was achieved at 10 Hz, in addition to an even lower response for higher frequencies: 400 Hz—43%, 100 Hz—55%, as can be seen in FIG. 30.

Continuing, the performance simulation was carried out for the Single-Phase ECD Inverter of the present invention. It was able to achieve performance values of around 91.2%, with a very satisfactory performance response, quite flat and linear at all simulated frequencies, as can be seen in FIG. 31.

The graph in FIG. 31 proves the improved efficiency performance that the ECD inverter of the present invention shows for various frequencies. Approximate yields of the order of 80% are verified for the 400 Hz frequency, 85% for 100 Hz, between 87 and 90% for the 40 Hz frequency and above 91% for the 10 Hz frequency. The responses are much higher if compared to the results presented by the conventional EIE inverter in FIG. 30.

Given these results, it was possible to demonstrate major gains in energy efficiency. An important observation must also be made regarding the semiconductor components used in the simulations described above: the IGBTs and fast recovery diodes used are not as efficient as the most modern ones available on the market. Much higher yields are obtained with the use of more current semiconductor devices, raising the yield of the ECD inverter of the present invention to new levels. In this way, higher yields should be obtained, with the target value of 95% being achieved with the ECD inverter topology of the present invention.

In order to further guarantee a higher value of efficiency in this new structure, it can be resorted to the implementation of an improved hysteresis control, varying the values of resistors R21 and R22 as a certain level of output THD is accepted, aiming maximum performance against the maximum acceptable harmonic distortion. It is known that using lower Reference1 voltage values results in better yields in conventional EIE topology. Likewise, this characteristic was also verified in simulation in the ECD inverter topology of the present invention. However, the use of lower reference voltage values leads to higher values of harmonic distortion in the inverter output voltage. It can be seen that the use of higher voltage in the reference corroborates the reduction in THD, although acting in an unfavorable or antagonistic way to the performance. Therefore, it is up to the designer to use values that optimize both performance and low THD.

### THD Simulations

The total harmonic distortion rate (THD) obtained in simulation, for the output voltage of the ECD inverter of the present invention was 3.69%, for the operating frequency set at 100 Hz, using up to the 50th harmonic. For the operating frequency set at 400 Hz, it was 3.59%. The values for each harmonic can be checked in the appendix at the end of the specification. The THDs were obtained with the ECD inverter of the present invention operating with a symmetric input voltage of 550 Vdc, a reference signal amplitude of 2 Vac and a gain of approximately 251 times, providing a phase-to-ground output voltage with a peak value of 517 Vac applied to a 2 Ω load.

It was verified and proven, however, that with the use of higher values in the reference voltage, lower THD values are achieved, with values of the order of 2% being obtained, as can also be seen in the appendix. For example, using a value of 3 Vac in the reference, adopting a gain of 167, and a 300 KΩ resistor in series with a 1.8 KΩ resistor in the feedback, a THD of 2% was obtained with an efficiency still high, close to 90.9%, at a frequency of 100 Hz. The phase-to-ground output voltage in this case reached a peak value of 503 Vac, applied to the same 2 $2 load. This fact corroborates and is an indication of the possibility of finding optimal values between efficiency and THD, changing the values of the feedback loop, as well as the reference voltage, still obtaining large output powers.

The values obtained in simulation demonstrate that the ECD inverter of the present invention is capable of reproducing sinusoidal voltage signals with low harmonic distortion.

### Voltage Regulation

### Load Insertion

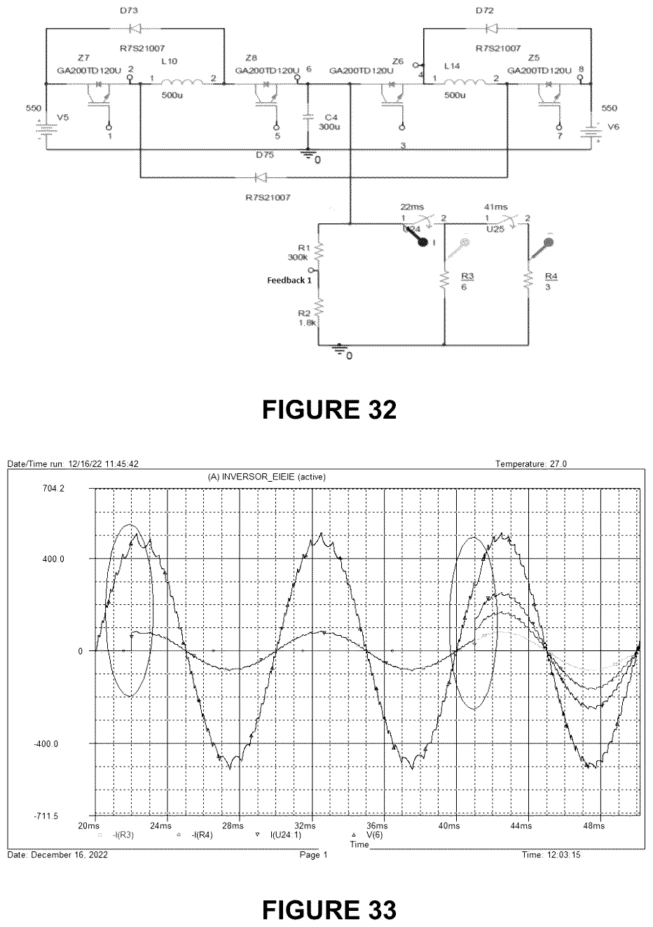

As previously mentioned, the ECD inverter of the present invention has an excellent characteristic in terms of regulation, not presenting overshoot in the event of sudden load variation. To prove the postulate, loads of 6 Ω and 3 Ω were used, inserted in an orderly manner through timed closing switches. The closing times of the switches were adjusted to 22 ms for the insertion of the 6 Ω resistor and 41 ms for the 3 Ω resistor, resulting in a final load of 2 Ω, as shown in FIG. 32. In this case, a value was used in the reference 3 Vac, adopting a gain of 167, parameters optimized for a THD of 2%, as seen in the previous section.

In FIG. 33, with the output voltage frequency set to 100 Hz, it can be seen in the indicated ellipses that the ECD inverter of the present invention did not present overshoot when the loads were inserted.

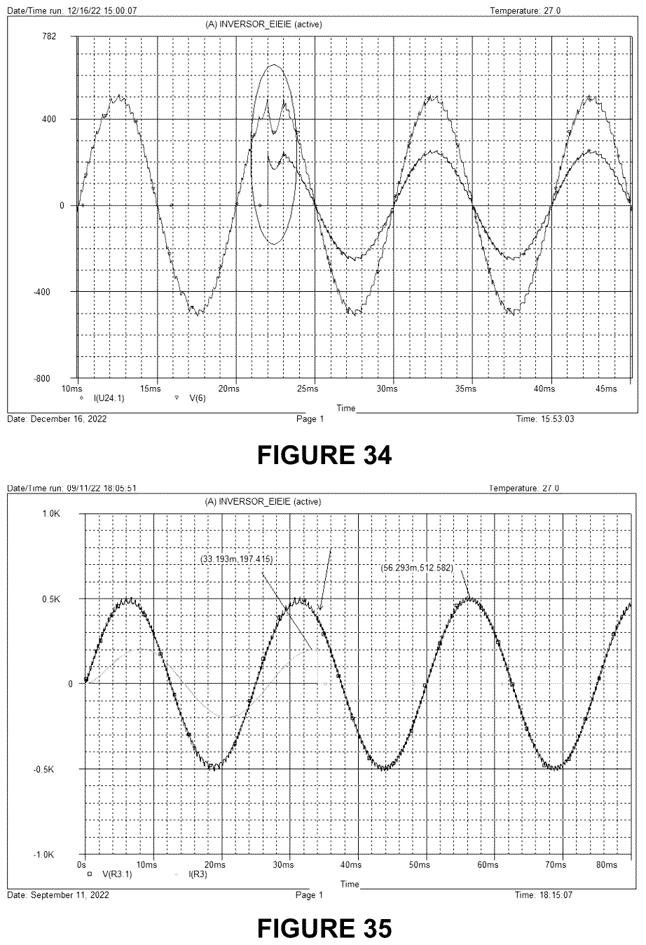

And as a test of Dynamic Regulation of the output voltage (step from 0 to 100% load), changing the load in FIG. 32 to just a 2 Ω resistor and a key activated in 22 ms, the response of FIG. 34 is obtained.

Clearly in both responses in FIGS. 33 and 34, the ability of the new ECD inverter topology of the present invention to maintain the output voltage stable in the face of large loads was visualized. The currents reached peak values of 84.9 A when the 6 Ω load was inserted and 169.2 A when the 3 Ω load was inserted, totaling a peak current of 254.2 A at the output. There is no overshoot when using the conventional EIE topology, but sags when large loads are inserted can occur.

In the case of the ECD inverter of the present invention, in addition to the absence of overshoot, there were also no severe voltage sags, demonstrating an excellent response of the new topology to the insertion of large loads. It is known that voltage sag in commercial converters exists when large load blocks are inserted, however the responses obtained here in simulation prove an extremely effective regulation for the ECD inverter topology of the present invention.

### Load Removal

To check the output voltage response to load removal, a timed opening switch was used, with opening time set to 34 ms. FIG. 35 shows that no overshoot occurred when the load was disconnected.

### Inductive Loads Supply

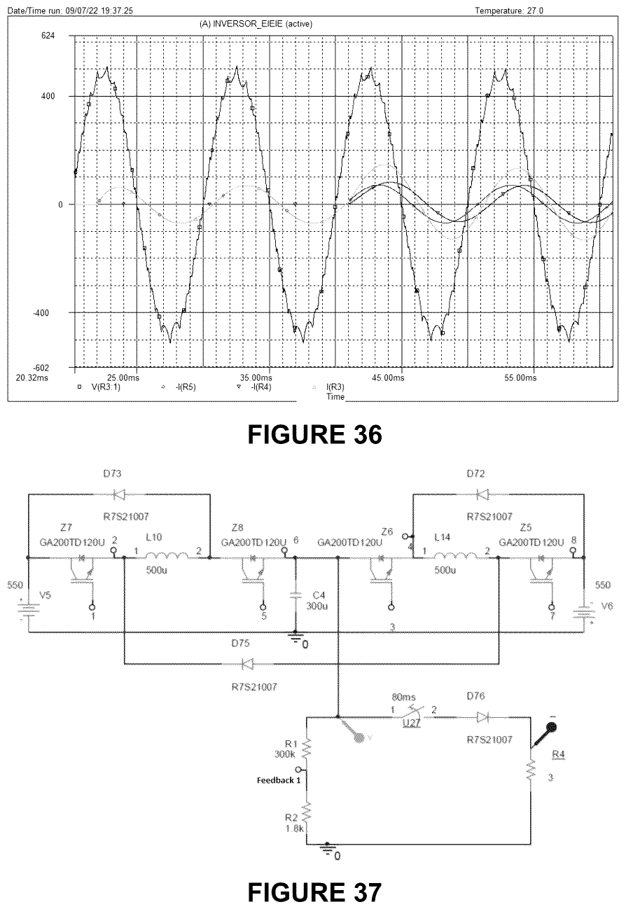

A simulation at a frequency of 100 Hz was also carried out, now using a load with a low power factor to demonstrate the operation of the ECD inverter of the present invention under these conditions. Inductors were associated, 5 mH in series with the 6 Ω resistor and 10 mH in series with the 3 Ω resistor, and the switches were kept operating with the same previous closing time intervals, 22 ms and 41 ms. As expected, the ECD inverter of the present invention maintained its operation with unchanged inductive load and again the output voltage response was maintained without apparent overshoot. No voltage sag was observed at the moments of insertion of both loads, as can be seen in FIG. 36. The perfect functioning of the ECD inverter of the present invention can be seen with loads with a low inductive power factor.

### Feeding Nonlinear Loads

In order to verify the operation of the ECD inverter of the present invention feeding non-conventional or non-linear loads, two simulations were carried out at a frequency of 100 Hz. The first, using a half-wave rectifier and a 3 Ω resistor as load, seen in FIG. 37. A timed opening switch with a time set at 80 ms was also used to interrupt the load supply. The half-wave rectifier, as it rectifies only one half-cycle of the output voltage of the inverter and, therefore, delivers power only in positive half-cycles, is an unusual load for applications at such high powers as in this example. Its choice here as a non-linear load was used only for didactic and validation purposes, to demonstrate the operation of the ECD inverter of the present invention in unique situations.

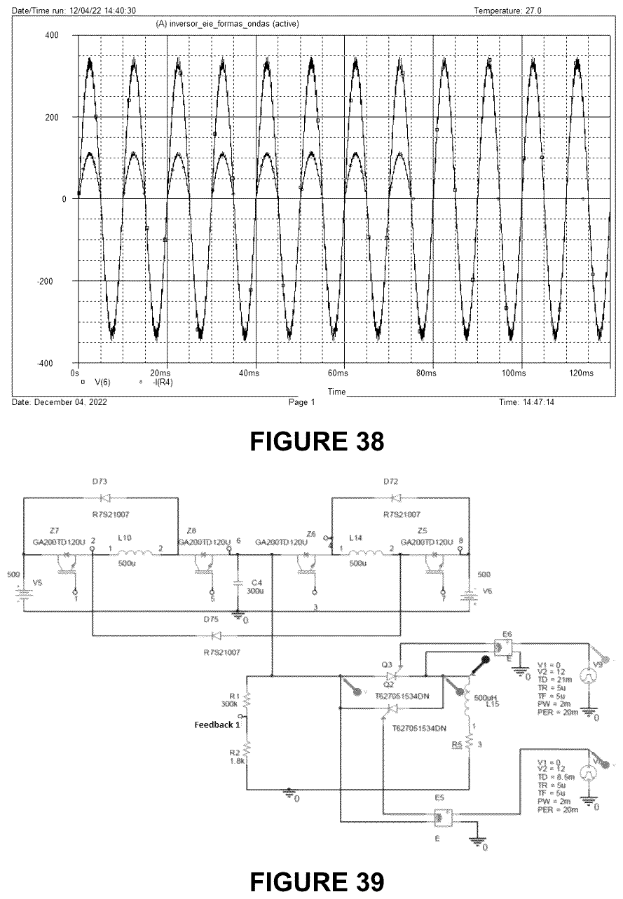

The ECD inverter of the present invention showed effectiveness and stability, not suffering variations in the output voltage waveform in this load condition, as can be seen in FIG. 38.

In the second simulation, illustrated in the circuit in FIG. 39, two thyristors were used in antiparallel feeding an RL load of 3 Ω and 500 μH. The trigger times were chosen randomly, with the aim of generating a non-linear current, being adjusted to 21 ms (α=36° and 8 ms (α=306° and a period of 20 ms adjusted for these trigger signals.

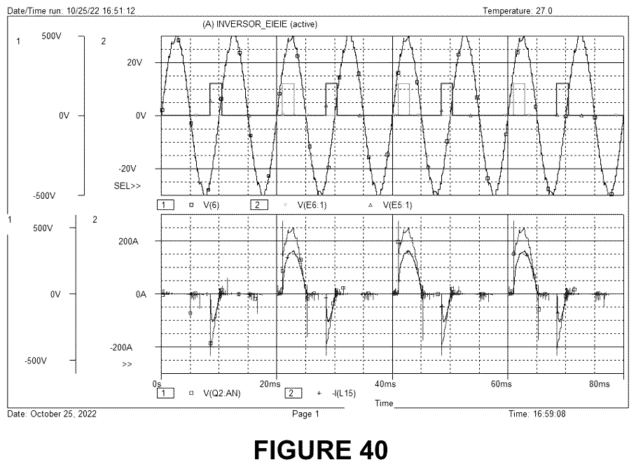

FIG. 40 below shows the inverter output voltage waveforms and thyristor trigger pulses at the top. In the lower part of the same figure, the voltage and current waveforms in the load RL are presented.

In line with the other results obtained, again the ECD inverter of the present invention showed reliability and a robust and effective response in its operation, showing an output voltage without interference or overshoots. Even with the existence of non-linear loads and high current values, the voltage remained sinusoidal without showing disturbances or disruptions.

### CONCLUSIONS

A new topology or electronic arrangement of an inverter, called a Single-Phase ECD Inverter, was presented in this disclosure. The sinusoidal output voltage without overshoot, high efficiency and electronic stability when supplying large loads and non-linear loads were characteristics found in this new structure. Among other positive points, the absence of the need for output filters and low harmonic distortion in the generated voltage can also be mentioned. The single-phase ECD inverter according to the present invention showed simplicity and robustness of operation, having only two operating stages. It does not require the so-called dead time circuits very common in “Full-bridge” topologies to avoid short circuits in the switching keys and the control of the output voltage is carried out in a closed loop, by complementary pulses generated simply by a device that acts as a hysteresis comparator.

The main waveforms of the ECD inverter according to the present invention were obtained through simulation software, as well as a performance study was showed, demonstrating high results when compared to the conventional EIE topology. The new inverter presented non-dissipative switching characteristics, providing the ZVS characteristics on switches S1 and S4 and ZCS on switches S2 and S3, increasing the performance of the structure and ensuring reduced EMI.

The search for an inverter capable of delivering variable sinusoidal voltage at its output, without a passive filter and that was capable of working with satisfactory and commercially applicable electrical performance, were the main characteristics and motivating factors for its creation. Such characteristics are highly advantageous and exclusive to the ECD inverter according to the present invention, resulting in the following technical effects and advantages:
mitigate engine bearing failures due to harmonics;
they do not generate degradation of insulation and burning of coils due to overvoltages due to wave reflections;
reduce acoustic noise;
reduce excessive vibrations;
they mitigate temperature increases and losses due to harmonics, therefore, they do not harm engine performance;
they eliminate the need to apply power derating to engines or use special engines;
reduce radiated and conducted noise-EMI, mainly in the feeders (cables) that supply the motors;

### APPENDIX

TABLE B
THD analysis for ECD Inverter output voltage at 400 Hz, using up to the
50^{th} harmonic:
Fourier components of the transient response V(6)
DC Component = 5.5374E−01

| Harmonic | Normalized | Normalized | | Component | Phase |
|---|---|---|---|---|---|
| frequency | Fourier phase | number (Hz) | Component | (degrees) | (degrees) |
| 1 | 4.0000E+02 | 5.0223E+02 | 1.0000E+00 | −9.2120E−01 | 0.0000E+00 |
| 2 | 8.0000E+02 | 2.2538E+00 | 4.4876E−03 | 5.9899E+01 | 6.1742E+01 |
| 3 | 1.2000E+03 | 4.5676E+00 | 9.0947E−03 | −1.4855E+01 | −1.2091E+01 |
| 4 | 1.6000E+03 | 3.6034E+00 | 7.1747E−03 | 8.4113E+01 | 8.7798E+01 |
| 5 | 2.0000E+03 | 2.7637E+00 | 5.5028E−03 | 2.3350E+01 | 2.7956E+01 |
| 6 | 2.4000E+03 | 4.9613E+00 | 9.8785E−03 | 1.2232E+02 | 1.2785E+02 |
| 7 | 2.8000E+03 | 1.9461E+00 | 3.8749E−03 | 6.4385E+01 | 7.0833E+01 |
| 8 | 3.2000E+03 | 5.8802E+00 | 1.1708E−02 | 1.7096E+02 | 1.7833E+02 |
| 9 | 3.6000E+03 | 1.9157E+00 | 3.8144E−03 | 1.1047E+02 | 1.1876E+02 |
| 10 | 4.0000E+03 | 3.7038E+00 | 7.3747E−03 | −1.4181E+02 | −1.3260E+02 |
| 11 | 4.4000E+03 | 1.9076E+00 | 3.7983E−03 | 1.5487E+02 | 1.6500E+02 |
| 12 | 4.8000E+03 | 2.0568E+00 | 4.0954E−03 | 4.6560E+01 | 5.7615E+01 |
| 13 | 5.2000E+03 | 1.9066E+00 | 3.7963E−03 | 1.6761E+02 | 1.7959E+02 |
| 14 | 5.6000E+03 | 6.7831E+00 | 1.3506E−02 | 9.1806E+01 | 1.0470E+02 |
| 15 | 6.0000E+03 | 1.4655E+00 | 2.9180E−03 | 1.2394E+02 | 1.3776E+02 |
| 16 | 6.4000E+03 | 8.5138E−01 | 1.6952E−03 | 5.9732E+01 | 7.4471E+01 |
| 17 | 6.8000E+03 | 1.3866E+00 | 2.7610E−03 | 6.1588E+01 | 7.7248E+01 |
| 18 | 7.2000E+03 | 5.3957E+00 | 1.0744E−02 | −5.4286E+01 | −3.7704E+01 |
| 19 | 7.6000E+03 | 1.7457E+00 | 3.4758E−03 | 2.4155E+01 | 4.1658E+01 |
| 20 | 8.0000E+03 | 6.7050E+00 | 1.3350E−02 | 1.4752E+02 | 1.6594E+02 |
| 21 | 8.4000E+03 | 2.3540E+00 | 4.6871E−03 | 1.0595E+02 | 1.2530E+02 |
| 22 | 8.8000E+03 | 3.8767E+00 | 7.7190E−03 | −9.0677E+00 | 1.1199E+01 |
| 23 | 9.2000E+03 | 2.8493E−01 | 5.6733E−04 | 9.9392E+01 | 1.2058E+02 |
| 24 | 9.6000E+03 | 2.5177E+00 | 5.0131E−03 | 1.3913E+02 | 1.6124E+02 |
| 25 | 1.0000E+04 | 6.2499E−01 | 1.2444E−03 | 5.5513E+00 | 2.8581E+01 |
| 26 | 1.0400E+04 | 1.6404E+00 | 3.2663E−03 | 4.4628E+01 | 6.8580E+01 |
| 27 | 1.0800E+04 | 1.5616E+00 | 3.1093E−03 | 2.2591E+01 | 4.7463E+01 |
| 28 | 1.1200E+04 | 1.5601E+00 | 3.1064E−03 | 6.6821E+01 | 9.2615E+01 |
| 29 | 1.1600E+04 | 6.8269E−01 | 1.3593E−03 | −2.0356E+01 | 6.3588E+00 |
| 30 | 1.2000E+04 | 1.0072E+00 | 2.0055E−03 | 1.5170E+01 | 4.2807E+01 |
| 31 | 1.2400E+04 | 7.7186E−01 | 1.5369E−03 | −1.4382E+02 | −1.1527E+02 |
| 32 | 1.2800E+04 | 1.1322E+00 | 2.2543E−03 | −3.2692E+01 | −3.2135E+00 |
| 33 | 1.3200E+04 | 2.1927E+00 | 4.3658E−03 | 1.1311E+02 | 1.4351E+02 |
| 34 | 1.3600E+04 | 5.9832E−01 | 1.1913E−03 | 5.7525E+01 | 8.8846E+01 |
| 35 | 1.4000E+04 | 1.6905E+00 | 3.3659E−03 | 5.6894E+01 | 8.9136E+01 |
| 36 | 1.4400E+04 | 4.3319E−01 | 8.6254E−04 | 6.0391E+01 | 9.3555E+01 |
| 37 | 1.4800E+04 | 2.0009E+00 | 3.9840E−03 | −2.1805E+01 | 1.2279E+01 |
| 38 | 1.5200E+04 | 7.6267E−01 | 1.5186E−03 | −5.3664E+01 | −1.8658E+01 |
| 39 | 1.5600E+04 | 3.8648E−01 | 7.6952E−04 | 1.0761E+02 | 1.4353E+02 |
| 40 | 1.6000E+04 | 1.0347E+00 | 2.0602E−03 | 1.3777E+02 | 1.7462E+02 |
| 41 | 1.6400E+04 | 1.4871E+00 | 2.9611E−03 | 1.3737E+01 | 5.1507E+01 |
| 42 | 1.6800E+04 | 9.1550E−01 | 1.8229E−03 | 1.1304E+01 | 4.9994E+01 |
| 43 | 1.7200E+04 | 1.4513E+00 | 2.8897E−03 | −1.2489E+02 | −8.5275E+01 |
| 44 | 1.7600E+04 | 3.8808E−01 | 7.7272E−04 | 7.9194E+01 | 1.1973E+02 |
| 45 | 1.8000E+04 | 6.6197E−01 | 1.3181E−03 | 6.3502E+01 | 1.0496E+02 |
| 46 | 1.8400E+04 | 6.8227E−01 | 1.3585E−03 | 6.6000E+01 | 1.0838E+02 |
| 47 | 1.8800E+04 | 3.3987E−01 | 6.7672E−04 | 9.2976E+01 | 1.3627E+02 |
| 48 | 1.9200E+04 | 8.1649E−01 | 1.6257E−03 | −1.3089E+01 | 3.1128E+01 |
| 49 | 1.9600E+04 | 1.2856E−01 | 2.5597E−04 | −1.6391E+02 | −1.1877E+02 |
| 50 | 2.0000E+04 | 9.5032E−01 | 1.8922E−03 | −9.0000E+01 | −4.3940E+01 |

Total harmonic distortion (THD) = 3.6956E+00%

TABLE C
THD analysis for the output voltage of the Single-Phase ECD Inverter at
100 Hz, using up to the 50^{th} harmonic, optimized with a reference voltage
of 3 Vac and approximate gain of 167.6. Yield of 90.9% and THD of 2.08%:
Fourier components of the transient response V(6)
DC Component = 4.5954E−02

| Harmonic | Normalized | Normalized | | Component | Phase |
|---|---|---|---|---|---|
| frequency | Fourier phase | number (Hz) | Component | (degrees) | (degrees) |
| 1 | 1.0000E+02 | 4.9546E+02 | 1.0000E+00 | −1.4543E−01 | 0.0000E+00 |
| 2 | 2.0000E+02 | 3.1086E−02 | 6.2741E−05 | 1.9893E+01 | 2.0184E+01 |
| 3 | 3.0000E+02 | 1.5376E+00 | 3.1033E−03 | −9.1512E+01 | −9.1076E+01 |
| 4 | 4.0000E+02 | 2.1218E−02 | 4.2824E−05 | 2.6763E+01 | 2.7345E+01 |
| 5 | 5.0000E+02 | 1.3995E+00 | 2.8247E−03 | −9.4337E+01 | −9.3610E+01 |
| 6 | 6.0000E+02 | 4.9241E−02 | 9.9385E−05 | 1.2263E+02 | 1.2350E+02 |
| 7 | 7.0000E+02 | 9.8355E−01 | 1.9851E−03 | −4.9963E+01 | −4.8945E+01 |
| 8 | 8.0000E+02 | 4.0628E−02 | 8.2001E−05 | 6.4377E+01 | 6.5540E+01 |
| 9 | 9.0000E+02 | 6.0091E−01 | 1.2128E−03 | −2.6834E+01 | −2.5525E+01 |
| 10 | 1.0000E+03 | 6.3596E−02 | 1.2836E−04 | −1.6749E+02 | −1.6604E+02 |
| 11 | 1.1000E+03 | 3.5015E−01 | 7.0671E−04 | 9.9474E−01 | 2.5945E+00 |
| 12 | 1.2000E+03 | 1.1116E−01 | 2.2437E−04 | 1.6656E+02 | 1.6830E+02 |
| 13 | 1.3000E+03 | 2.2909E−01 | 4.6237E−04 | 1.7706E+01 | 1.9596E+01 |
| 14 | 1.4000E+03 | 1.6940E−02 | 3.4190E−05 | −1.3894E+02 | −1.3690E+02 |
| 15 | 1.5000E+03 | 1.3514E−01 | 2.7275E−04 | −1.3505E+02 | −1.3287E+02 |
| 16 | 1.6000E+03 | 9.6538E−02 | 1.9485E−04 | −1.5330E+02 | −1.5098E+02 |
| 17 | 1.7000E+03 | 2.1959E−01 | 4.4320E−04 | 2.1714E+01 | 2.4186E+01 |
| 18 | 1.8000E+03 | 1.7150E−01 | 3.4615E−04 | 3.0101E+01 | 3.2719E+01 |
| 19 | 1.9000E+03 | 5.4586E−01 | 1.1017E−03 | −1.3986E+02 | −1.3710E+02 |
| 20 | 2.0000E+03 | 3.9177E−01 | 7.9072E−04 | −1.5692E+02 | 1.5401E+02 |
| 21 | 2.1000E+03 | 7.5524E−01 | 1.5243E−03 | 2.8671E+01 | 3.1725E+01 |
| 22 | 2.2000E+03 | 5.7527E−01 | 1.1611E−03 | 5.4892E+01 | 5.8092E+01 |
| 23 | 2.3000E+03 | 1.5601E+00 | 3.1488E−03 | −1.2867E+02 | −1.2533E+02 |
| 24 | 2.4000E+03 | 9.7915E−01 | 1.9762E−03 | −1.3931E+02 | −1.3582E+02 |
| 25 | 2.5000E+03 | 1.8504E+00 | 3.7346E−03 | 4.6713E+01 | 5.0349E+01 |
| 26 | 2.6000E+03 | 9.7552E−01 | 1.9689E−03 | 6.7248E+01 | 7.1029E+01 |
| 27 | 2.7000E+03 | 2.6135E+00 | 5.2748E−03 | −1.1258E+02 | −1.0865E+02 |
| 28 | 2.8000E+03 | 1.4885E+00 | 3.0042E−03 | −1.1766E+02 | −1.1359E+02 |
| 29 | 2.9000E+03 | 2.3586E+00 | 4.7604E−03 | 6.3102E+01 | 6.7319E+01 |
| 30 | 3.0000E+03 | 8.1652E−01 | 1.6480E−03 | 7.0494E+01 | 7.4857E+01 |
| 31 | 3.1000E+03 | 1.2318E+00 | 2.4863E−03 | −1.0925E+02 | −1.0474E+02 |
| 32 | 3.2000E+03 | 2.2201E−01 | 4.4808E−04 | −1.2940E+02 | −1.2474E+02 |
| 33 | 3.3000E+03 | 8.0307E−01 | 1.6209E−03 | −1.1182E+02 | −1.0702E+02 |
| 34 | 3.4000E+03 | 6.0270E−01 | 1.2164E−03 | −1.1033E+02 | −1.0539E+02 |
| 35 | 3.5000E+03 | 1.4409E+00 | 2.9081E−03 | 1.1559E+02 | 1.2068E+02 |
| 36 | 3.6000E+03 | 1.4149E+00 | 2.8558E−03 | 1.2045E+02 | 1.2569E+02 |
| 37 | 3.7000E+03 | 3.5081E+00 | 7.0804E−03 | −8.2986E+01 | −7.7605E+01 |
| 38 | 3.8000E+03 | 1.4018E+00 | 2.8294E−03 | −1.3467E+02 | −1.2915E+02 |
| 39 | 3.9000E+03 | 3.1564E+00 | 6.3706E−03 | −3.5568E+01 | −2.9896E+01 |
| 40 | 4.0000E+03 | 2.2216E+00 | 4.4839E−03 | −9.7171E+01 | −9.1353E+01 |
| 41 | 4.1000E+03 | 4.1756E+00 | 8.4278E−03 | 5.3749E+01 | 5.9711E+01 |
| 42 | 4.2000E+03 | 6.2222E−01 | 1.2558E−03 | −7.6736E+00 | −1.5656E+00 |
| 43 | 4.3000E+03 | 2.4488E+00 | 4.9425E−03 | 6.8931E+01 | 7.5185E+01 |
| 44 | 4.4000E+03 | 5.2372E−01 | 1.0570E−03 | 5.0087E+01 | 5.6486E+01 |
| 45 | 4.5000E+03 | 2.8702E−01 | 5.7931E−04 | 7.9249E+01 | 8.5793E+01 |
| 46 | 4.6000E+03 | 7.3146E−01 | 1.4763E−03 | −2.8051E+01 | −2.1362E+01 |
| 47 | 4.7000E+03 | 1.6260E+00 | 3.2817E−03 | 1.3853E+02 | 1.4537E+02 |
| 48 | 4.8000E+03 | 1.4232E+00 | 2.8725E−03 | −1.3498E+02 | −1.2800E+02 |
| 49 | 4.9000E+03 | 3.1054E+00 | 6.2677E−03 | 8.9322E+01 | 9.6448E+01 |
| 50 | 5.0000E+03 | 1.0903E+00 | 2.2006E−03 | 1.1945E+02 | 1.2672E+02 |

Total harmonic distortion (THD) = 2.0818E+00%

Although aspects of the present disclosure may be susceptible to various modifications and alternative forms, specific embodiments have been shown by way of example in the drawings and have been described in detail herein. But it should be understood that the invention is not intended to be limited to the particular forms disclosed. Instead, the invention must cover all modifications, equivalents and alternatives that fall within the scope of the invention as defined by the following appended claims.

1. A frequency inverter comprising:
at least three diodes and at least two inductors,
wherein one of the at least three diodes operates sometimes in a discharge of one of the at least two inductors and sometimes in the discharge of the other inductor;
at least one depolarized capacitor connected to inverter output terminals;
at least four switching keys, wherein at least two of the four switching keys are current bidirectional keys; and
a control circuit.

2. The frequency inverter of claim 1, wherein the control circuit is a hysteresis comparator.

3. The frequency inverter of claim 1, wherein a capacitor is connected in parallel to a load.

4. The frequency inverter of claim 1, wherein a voltage divider is connected in parallel to a load, and wherein a voltage sample is sent from a middle of the voltage divider to the control circuit.
